(19) United States
(12) Patent Application Publication
(10) Pub. No.: US 2008/0084054 A1
(43) Pub. Date: Apr. 10, 2008

(54) Rollover-protection system for motor vehicles with at least one actively deployable roll bar

(75) Inventors: Frank Liesaus, Bergneustadt (DE); Hans Gerd Menne, Bergneustadt (DE)

Correspondence Address: FLASTER/GREENBERG P.C.;8 PENN CENTER, 1628 JOHN F. KENNEDY BLVD., 15TH FLOOR, PHILADELPHIA, PA, 19103, US

(73) Assignee: Automotive Group ISE Innomotive Systems Europe GmbH, Bergneustadt (DE)

(21) Appl. No.: 11/973,662

(22) Filed: Oct. 10, 2007

(30) Foreign Application Priority Data
Oct. 10, 2006 (DE) 10 2006 048 085.6

(51) Int. Cl. B60R 21/13

(52) U.S. Cl. 280/756

(57) ABSTRACT

The invention is of a rollover-protection system for motor vehicles with at least one roll bar, which is received in a leading vehicle-mounted bracket by means of its bar shanks, and in its normal state, it is kept in a lower, non-obtrusive resting position by a holding device, with the sensor-driven releasing of the holding device, it can be brought into a locked, supporting position by a store of energy. With the use of a raw material made from one piece, an especially economical, highly efficient leading vehicle-mounted bracket that reinforces the body of the vehicle can be manufactured, which houses the deployable roll bar.

### BACKGROUND OF THE INVENTION

1. Field of the Invention

The invention applies to rollover-protection systems for motor vehicles with at least one deployable roll bar, sensor-driven from a resting position into a supporting position by means of its bar shanks, which are connected to each other with a bar yoke and are received in corresponding support shanks of a leading vehicle-mounted bracket, wherein the bracket's shanks are connected to each other with at least one upper support yoke.

2. Description of Related Art

Such rollover-protection systems serve to protect the passengers in motor vehicles without protective roofs, typically in convertibles or sports cars, by creating a survival space for the passengers in the case of an accident.

It is common, in doing so, to equip one of the fixed roll bars spanning the entire width of the vehicle (EP 0 233 777 B2) or to provide each seat with a fixed-height in-car roll bar (DE 196 04 423 A1). Aside from these so-called fixed roll bars, there are also widely adopted design-engineering solutions for so-called active roll-bar systems on the market. With these, the roll bar lays flat in the normal state and in the case of danger, i.e. an impending accident, it is quickly set into a protective locked position by a sensor, using a store of energy. This serves to prevent the vehicle's passengers from being injured if the vehicle rolls.

These so-called “active” rollover-protection systems typically feature U-shaped roll bars in-line with the bar shanks for each seat, in a fixed housing. In the normal state, a holding device keeps them in a lower resting position against the preload force of a pressure spring mechanism. In the case of a rollover, with the releasing of the holding device, they are guided into an upper, supporting position by a sensor, driven by the preload force, whereby a locking mechanism engages to prevent the roll bar from sliding back into the housing.

Such a housing construction for an active rollover-protection system is exemplarily shown in DE 100 40 642 C1.

Aside from the housing construction, active rollover-protection systems are also available according to a design principle with a rear-panel assembly, as exemplarily described in DE 103 44 446 B3. Such a system features a frame construction between the rear passenger compartment and the trunk, made up of both a profile cross member fixed to the body, spanning the inside width of the vehicle, which works as a means of guiding the bar shanks of two neighboring U-shaped roll bars, and also made up of profile mounting elements extending vertically downward, with a ground segment for the acceptance of the applicable components from the executable rollover-protection system, like the activation magnets for the sensor-driven activation of the roll bar deployment motion as well as the pressure spring mechanism. It is also common to integrate two housing systems, each with an active roll bar on a rear-panel mounting (DE 100 44 926 C1).

Both the housing constructions and the cross-member constructions have been introduced into the market and into use in numerous variations, adapted to the respective vehicle type.

There are also rollover-protections systems known, with an actively deployable roll bar spanning roughly the total vehicle width. In these, the bar head can be designed as a persistent bar jacket (DE 195 40 819 C2), or can feature bar-head-like moldings near the vehicle seats (DE 100 44 930 C1).

DE 41 00 506 C1 shows a vehicle-width executable roll bar, which is housed in a rectangular, closed, fixed guide frame. The guide frame is made up of a number of individual elements. Along with the number of individual components, the known construction has the disadvantage of no load-through possibility.

DE 10 2004 035 015 B3 shows a rollover-protection system that is, above all, made up of a rollover-body based on a vehicle seat without a sensor-driven crash system. This system is made up, like DE 41 00 506 C1, of multiple parts. This requires a separate crossbar which is lead by its lateral ends to the side frame attached to the guide block in order to enable the rollover body to be able to move.

The invention is based on the task of designing the initially identified rollover-protection system in such a way that the guiding vehicle-mounted bracket is formed so that it can be economically manufactured from simple parts and also serves to reinforce the vehicle.

### BRIEF SUMMARY OF THE INVENTION

The solution of this task can be found in rollover-protection systems for motor vehicles with at least one deployable roll bar, sensor-driven from a resting position into a supporting position by means of its bar shanks, which are connected to each other with a bar yoke and are received in corresponding support shanks of a leading vehicle-mounted bracket, wherein the support shanks of the bracket are connected to each other with at least one upper support yoke, according to the invention, so that the support shanks and the support yoke of the leading vehicle-mounted bracket are connected to each other in one piece.

The measures, according to the invention, which build on the design principles of DE 41 00 506 C1, mentioned above, but reduce its disadvantages, lead to the advantage of an economically producible bracket for the rollover-protection systems.

Even in the automobile supplier industry there are enormous cost pressures, which necessitate simple, less costly and therefore highly efficient constructions.

The leading vehicle-mounted bracket for the rollover-protection system, according to the invention, is one piece. Here, one piece means that the raw material is comprised of only one piece, i.e. it is not assembled from multiple components. This is advantageously achieved if the raw material is a metal blank that, with various casting and die processes, to a finished product will be formed. But also raw materials can find use, like a pipe, that does not have to feature a circular cross section, but can also have other geometries. Moreover, extruded profiles with various cross sections, with or without shaped segments to fasten to the body or to fasten to other components, can be used as raw material. The profiles can either be full profiles, half-hollow profiles or even hollow profiles.

To manufacture the leading vehicle-mounted bracket, any arbitrary material can fundamentally be used, so long as it fulfills the required strength properties. Therefore, steel, plastic, especially fiber-reinforced plastic, and aluminum can be used.

The leading vehicle-mounted bracket for a rollover-protection system, according to the invention, offers the possibility of integrating all of the components necessary for an active rollover-protection system, like the trigger unit, the holding device to hold down the roll bar in the resting state, the guidance of the deployable part of the rollover-protection system and the mechanism to lock the deployed roll bar.

These components or modules can be added after the fact if the leading vehicle-mounted bracket is already part of the bodyshell. However, the components or modules can also be incorporated into a rollover-protection system supplied on the assembly line, so that the entire rollover-protection system is supplied as an already functioning system.

New technologies have enabled the creation of the item, according to the invention, so that it does not lead to the formation of cracks in the corner areas.

The large passenger-compartment space occurring between the support shanks of the leading vehicle-mounted bracket is especially advantageous. Here, the available space can be used as a load-through window. There is even more space available in the systems that are almost as wide as the vehicle, but seat-based bars will create space for a load-through window.

There are no weak points in the item, according to the invention, as is the case with multiple-piece profiles, especially in the connecting areas where bearing stress can occur or the material can be weakened by welding and/or soldering processes.

The design, according to the invention, strengthens the body of vehicles that have been in an accident at the main stress points. With this, the ends of the support shanks facing the direction of the floor of the vehicle can be directly attached to the floor of the vehicle, resulting in a closed “shell” that represents the according reinforcement of the body. This “shell” has weak points at the attachment points to the floor of the car in the one-piece design of the item, according to the invention; otherwise, it is a very stable one-piece “shell.” The support shanks can be further secured in the area of the load-bearing elements at the sides of the vehicle. It can also be connected to the vehicle elements that extend along the vehicle's longitudinal axis and end in the vicinity of the invention. With this, it is affixed at all three of the principle vehicle axes.

Corresponding designs and further information on the invention is noted in the dependent claims and can also be obtained from the following figure descriptions.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. The invention will be more closely examined with the help of two beneficial execution examples shown in the patent drawings in various views and states:

FIG. 1 Frontal view of a rollover-protection system with a leading vehicle-mounted bracket, spanning nearly the entire width of the car, with an actively deployable roll bar in the resting position.

FIG. 2 Frontal view corresponding to FIG. 1, but with an activated roll bar.

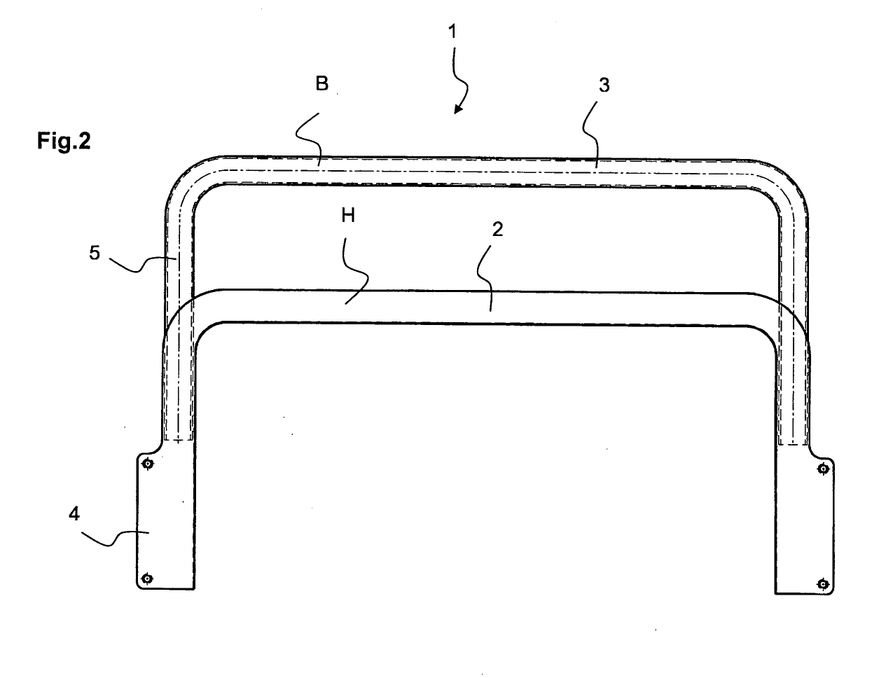

FIG. 3 Longitudinal cross sectional vehicle profile, according to FIG. 1.

FIG. 4 Frontal view of a rollover-protection system with a leading vehicle-mounted bracket, spanning nearly the entire width of the car; however, with two actively deployable roll bars in the resting position.

FIG. 5 Frontal view corresponding to FIG. 4, but with two activated roll bars, and

FIG. 6 Isometric view of the system corresponding to FIG. 5.

### DETAILED DESCRIPTION OF THE INVENTION

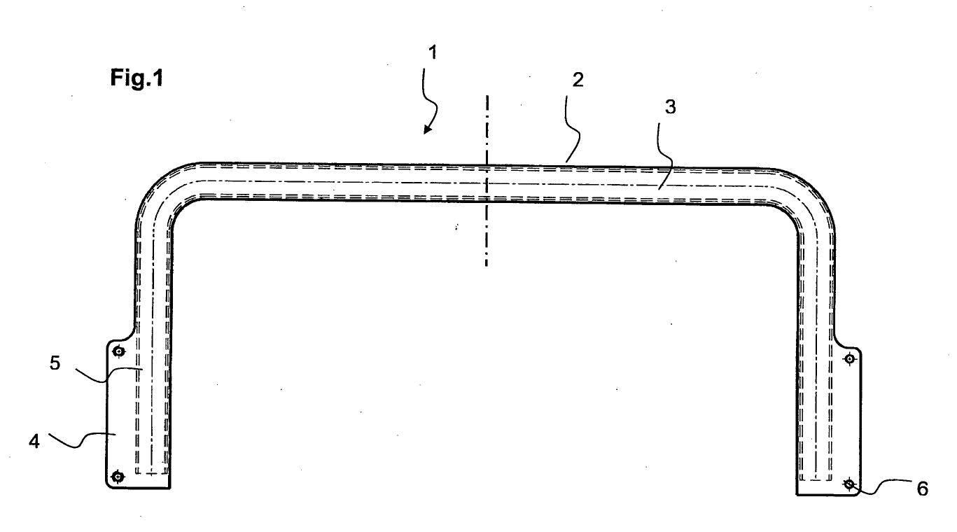

FIG. 1 shows, in a heavily schematized illustration, a rollover-protection system 1 spanning nearly the entire width of the vehicle. Here, the deployable roll bar 3 is in the resting position in the leading vehicle-mounted bracket 2.

The components required for the function of the active rollover-protection system, like the trigger unit, the holding device for the inactive roll bar and the locking mechanism for the activated roll bar, are not depicted, but are sufficiently known from the relevant protective rights, especially from the applicant.

The deployable roll bar 3 shows, in the longitudinal view of the vehicle, a somewhat U-shaped profile with attached bar shanks 5, which are attached to each other using a bar yoke B.

The leading vehicle-mounted bracket 2, is also fundamentally U-shaped, but it broadens near the support shanks 4, compared to the other profile. This is especially advantageous in order to house the trigger unit, the holding device and the locking mechanism. Furthermore, the broadening of the support shanks 4 can also be used to complementarily secure the bracket 2 to the vehicle body using the mounting holes 6 or also using mounting bolts.

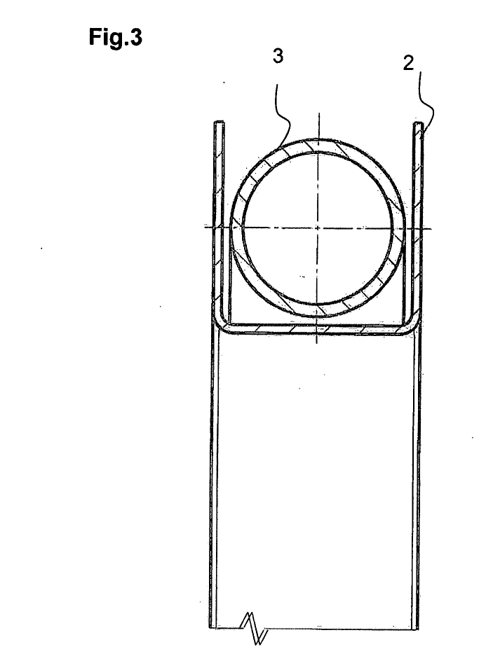

The cross section in FIG. 3, of the portion connecting the two support shanks 4 to the bracket 2, shows the U-form of the profile with the deployable roll bar 3 placed in the resting position. The cross section of the roll bar 3 profile does not have to be circular; it may also form a different shape.

The cross section of the leading vehicle-mounted bracket 2 can also deviate from the depicted form. It is possible, for example, that the profile is completely closed and the areas where the bar shanks 5 meet the deployable roll bar 3 are open. In this case, the vehicle body would be advantageously reinforced. With this embodiment, the deployable roll bar 3, with its bar yoke B connecting the bar shanks 5 would then sit above the profile of both of the support shanks 4 of the lead vehicle-mounted bracket 2.

It is shown to be advantageous for the profile of the leading vehicle-mounted bracket 2 to be partially closed and partially open. With this, the profile section connected by both of the support shanks 4 can be opened and the profile section in the area of the support shanks 4 can be partially closed. This has the advantage that the deployable roll bar 3 is inside of the leading vehicle-mounted bracket 2 with its cross expansion.

It is shown to be especially advantageous if the leading vehicle-mounted bracket 2 is an extrusion profile on which, based on need, segments are formed, to which various components can be attached or which can serve to attach it to the body of the vehicle. With this, aluminum extrusion profiles can be used, or also profiles that are manufactured using hydroforming or heat deformation.

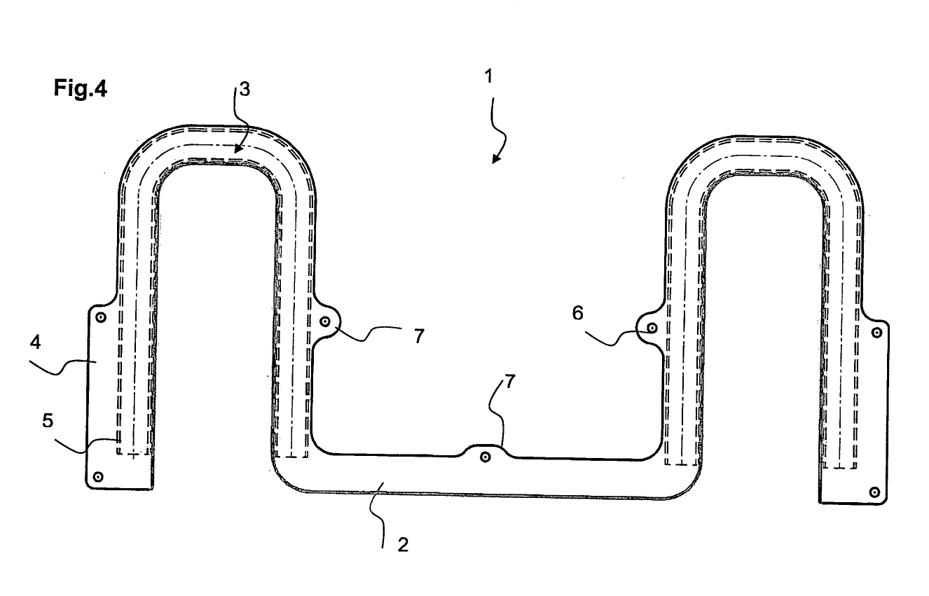

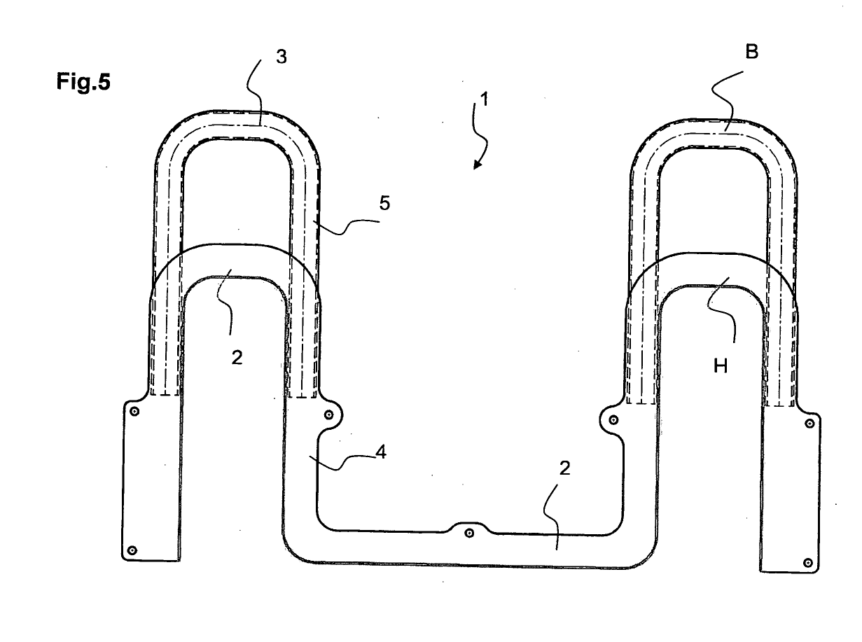

FIGS. 4, 5 and 6 show a second embodiment of an active rollover-protection system 1. This is a system with two separate deployable roll bars 3. The profile form of the deployable roll bar 3 can deviate from a circular form in this embodiment, as already explained above.

The leading vehicle-mounted bracket 2, viewed from the driving direction, has a double U-shaped profile. The area of the support shank 4 also broadens here, as already described, in order to be able to house the various components and to be able to fasten the rollover-protection system 1 to the vehicle's body using the mounting holes 6 or mounting bolts.

Flanges 7 are affixed to the middle area of the leading vehicle-mounted bracket 2. These serve, on the one hand, to seat the mounting holes 6 or allow the mounting bolts to be able to attach the rollover-protection system 1 to the body of the vehicle and, on the other hand, to attach other components to this. The flanges 7 can be variably mounted to the entire M-shaped cross section.

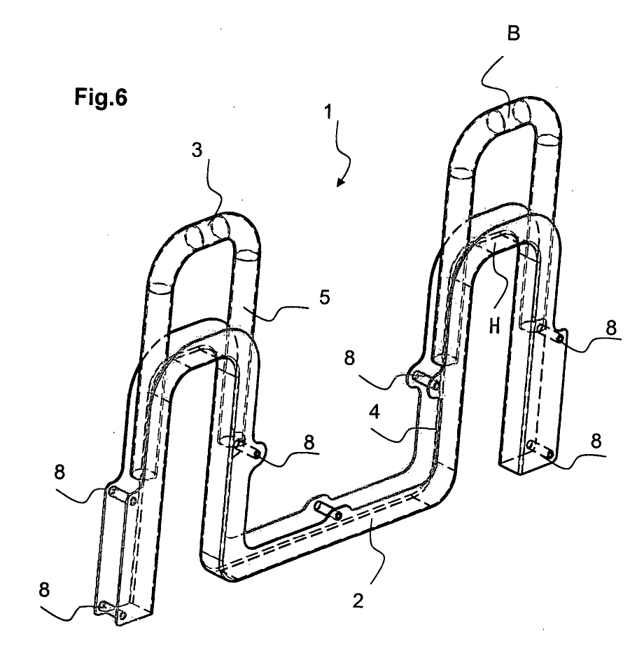

In order to be able to secure the leading vehicle-mounted bracket 2 onto the body, as seen in FIG. 6, couplers 8 are inserted in between the U-shaped profile of the bracket 2. This has the advantage of being easily mounted in the assembly of the leading vehicle-mounted bracket 2 without having to reach between the U-shaped profile. At the same time, the vehicle-mounted bracket 2 is additionally reinforced.

Both for the deployable roll bar 3 and for the leading vehicle-mounted bracket 2, a wide array of materials can be used based on availability and the strength requirements.

Furthermore, it is possible to make the item, according to the invention, available for two seat-based rollover-protection systems in the form of a single housing.

Reference List

1 Rollover-Protection System

2 Leading Vehicle-Mounted Bracket

3 Deployable Roll Bar

4 Support Shank

5 Bar Shank

6 Mounting Holes

7 Flange

8 Coupler

B Bar Yoke

H Support Yoke

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A rollover-protection system for powered vehicles comprising at least one deployable roll bar, sensor-driven from a resting position into a supporting position by means of its bar shanks, which are connected by a bar yoke and are received in corresponding support shanks of a leading vehicle-mounted bracket, wherein the support shanks of the bracket are connected to each other with at least one upper support yoke, and wherein the support shanks and the support yoke of the leading vehicle-mounted bracket are connected to each other in one piece.

2. The rollover-protection system according to claim 1, wherein the leading vehicle-mounted bracket is equipped with support shanks that are positioned in line with the floor of the vehicle.

3. The rollover protection system according to claim 2, wherein the support shanks of the leading vehicle-mounted bracket are connected to the body of the vehicle, reinforcing it.

4. The rollover-protection system according to claim 3, wherein the leading vehicle-mounted bracket is a profile body.

5. The rollover-protection system according to claim 4, wherein the leading vehicle-mounted bracket is created from an aluminum extrusion profile.

6. The rollover-protection system according to claim 4, wherein the leading vehicle-mounted bracket is made from a full profile, half-hollow profile or a hollow profile.

7. The rollover-protection system according to claim 1, wherein the leading vehicle-mounted bracket contains at least partial openings.

8. The rollover-protection system according to claim 1, wherein the leading vehicle-mounted bracket features flanges.

9. The rollover-protection system according to claim 1, wherein the vehicle-mounted bracket is constructed so that there is free space available between its support shanks.

10. The rollover-protection system according to claim 1, wherein the support yoke of the bracket is constructed as a guttered half-hollow profile in a way that, when the roll bar is in a resting state, the bar yoke of the bar shanks can be received by the support yoke of the support shanks.

11. The rollover-protection system according to claim 9, wherein, with the roll bar in the resting state, the bar yoke of the bar shanks lies above the support yoke that connects the support shanks.

12. The rollover-protection system according to claim 9, wherein, with a seat-based rollover-protection system, two leading vehicle-mounted brackets are located spaced-out next to each other, whose opposing support shanks are connected to each other in one piece along the side of the floor of the vehicle, creating free space.

13. The rollover-protection system according to claim 10, wherein the geometric contours of the bar yoke and the support yoke are aligned with each other.
